(19) United States
(12) Patent Application Publication
(10) Pub. No.: US 2026/0155403 A1
(43) Pub. Date: Jun. 4, 2026

(54) SEPARATOR FOR FUEL CELL

(71) Applicants: Hyundai Motor Company, Seoul (KR); Kia Corporation, Seoul (KR)

(72) Inventors: Woo Chul Shin, Hwaseong-si (KR); Sun Do Shin, Hwaseong-si (KR)

(21) Appl. No.: 19/174,696

(22) Filed: Apr. 9, 2025

(30) Foreign Application Priority Data
Nov. 29, 2024 (KR) 10-2024-0174360

(51) Int. Cl. H01M 8/0263; H01M 8/0258

(52) U.S. Cl. CPC H01M 8/0263; H01M 8/0258

(57) ABSTRACT

In an embodiment a separator arrangement includes a first separator having a straight channel flow path and a second separator having a wavy channel flow path, wherein the first and second separators are repeatedly stacked, wherein the second separator includes a land extension formed in a folded area of a land portion adjacent to a non-reaction flow path located at a top of the second separator in a reaction area of each of the first separator and the second separator.

### CROSS-REFERENCE TO RELATED APPLICATIONS

This application claims, under 35 U.S.C. § 119(a), the benefit of priority from Korean Patent Application No. 10-2024-0174360, filed on Nov. 29, 2024,the entire contents of which are incorporated herein by reference.

### TECHNICAL FIELD

The present disclosure relates to a separator for a fuel cell, and more particularly, to a separator for a fuel cell capable of preventing generation of water in a non-reaction channel flow path by increasing the land portion of the non-reaction flow path that invades a reaction area.

### BACKGROUND

In general, a fuel cell is a device that electrochemically converts chemical energy of fuel into electrical energy directly within the cell, rather than converting the same into heat by combustion, and is a pollution-free power generator that is being studied with interest as a power source for vehicles, laser electric devices, etc.

Hydrogen, which is a fuel gas, is supplied to the anode of the fuel cell, and oxygen, which is an oxidizing agent, is supplied to the cathode. In order to separate electrons from hydrogen and oxygen and promote ionization, a humidifying device for supplying moisture to hydrogen gas and oxygen gas is provided to each of the anode and cathode of the fuel cell.

Fuel cells are classified into solid oxide fuel cells, molten carbonate fuel cells, polymer electrolyte membrane fuel cells, and direct methanol fuel cells, depending on the operating temperature and the type of electrolyte.

In a fuel cell, electrochemical reaction includes two reactions: oxidation reaction at the anode and reduction reaction at the cathode. The two electrodes include a catalyst layer using platinum or platinum and ruthenium metal to promote oxidation and reduction. To decrease the amount of the platinum catalyst used and increase the utilization rate thereof, fine carbon particles are used as a catalyst support. Power, heat, and water are finally produced as reaction results. The water produced at the cathode is in the form of water and steam, and is generally removed by allowing reducing gas (oxygen or air) to strongly flow toward the cathode.

A unit cell that forms the basis of a stack includes two electrodes, an anode and a cathode, separated by a polymer electrolyte membrane, and the anode and the cathode on respective outer surfaces of the polymer electrolyte membrane are hot-pressed to form a membrane-electrode assembly (MEA). The membrane-electrode assembly is supported by a separator that has a flow path configured to supply hydrogen as a fuel (methanol in the direct methanol fuel cell) and oxygen or air as a reducing gas and to discharge water generated by redox reaction. A gasket is provided to prevent gas or liquid supplied or discharged through the flow path of the separator from leaking. Unit cells composed of the membrane-electrode assemblies, the separators, and the gaskets are stacked in series to obtain the required output, and the stack is formed by fixing with end plates at both ends as fixing means.

The separator serves to prevent fuel (hydrogen, methanol) and reducing gas (oxygen, air) from mixing with electrolyte in the cell and to electrically connect the two electrodes, and to also serve as a mechanical support for the stacked unit cells. The separator allows fuel gas (hydrogen, methanol) and reducing gas (oxygen, air) to uniformly flow to the electrodes through the flow path formed on the surface thereof and functions to prevent the membrane from drying out through appropriate moisture control. When operating a polymer electrolyte fuel cell, it is important to supply sufficiently humidified fuel and reducing gas (oxygen, air).

Under high-current operation conditions exceeding the critical current density, water generated by electrochemical reaction and water moved from the anode by electroosmosis are excessively present at the cathode. Some of the excess water evaporates into the reducing gas (oxygen or air) flowing in the separator channel, saturating the reducing gas, and the water that does not evaporate is present in a liquid state in the gas diffusion layer (GDL) or the separator channel.

Excess water present in the gas diffusion layer or the separator channel, if not discharged to the outside by appropriate engineering mechanisms, may cause flooding, adversely affecting fuel cell performance or reliability.

### SUMMARY

Embodiments provide a separator for a fuel cell, in which, in a separator structure in which a parallel or straight channel and a wavy channel are repeatedly stacked, the land of the non-reaction flow path of the wavy channel that invades the set reaction area is increased, thus preventing generation of water in the non-reaction flow path, thereby improving water discharge performance in a low-temperature/low-current section where water discharge performance is weakened, ultimately effectively improving stack performance.

The present disclosure provides a separator for a fuel cell in which a first separator including a parallel channel flow path and a second separator including a wavy channel flow path are repeatedly stacked, in which the separator includes a land extension formed in a folded area of a land portion adjacent to a non-reaction flow path located at a top of the second separator in a reaction area formed in each of the first separator and the second separator.

The land extension may be formed to extend in a direction in which the folded area faces the top of the second separator to coincide with a boundary of the reaction area.

Here, the land extension may be formed to extend in a direction of flow of a reaction gas in the folded area so that a length of one side is identical to a length of the other side and a length of a center side is greater than lengths of the one side and the other side.

Also, the land extension may be formed to extend in a direction in which the folded area faces the top of the second separator to exceed a boundary of the reaction area.

The land extension may be formed to face a land portion of a non-reaction flow path located at the top of the first separator.

The land extension may be formed to extend in a direction of flow of the reaction gas in the folded area so that a length of one side is identical to a length of the other side and a length of a center side is greater than lengths of the one side and the other side.

The land extension may be formed to be connected to a reverse forming portion that is folded in an opposite direction facing a gas diffusion layer in the folded area.

The land extension may be formed at each of one side and the other side of the folded area and may be connected to the reverse forming portion.

Here, a circulation flow path for a reaction gas in the non-reaction flow path may be formed by connecting the land extension to the reverse forming portion.

Meanwhile, the first separator may be formed so that oxygen flows along the parallel channel flow path, and the second separator may be stacked to face the first separator so that reaction areas coincide with each other, and may be formed so that hydrogen flows along the wavy channel flow path.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1A to 1C show a conventional separator for a fuel cell;

FIG. 2 shows a land extension of a separator for a fuel cell according to a first embodiment of the present disclosure;

FIG. 3 is a cross-sectional view along line A-A of FIG. 2 to show the land extension of the separator for a fuel cell according to the first embodiment of the present disclosure;

FIG. 4 shows a land extension of a separator for a fuel cell according to a second embodiment of the present disclosure;

FIG. 5 is a cross-sectional view along line A-A of FIG. 4 to show the land extension of the separator for a fuel cell according to the second embodiment of the present disclosure; and

FIG. 6 shows a land extension of a separator for a fuel cell according to a third embodiment of the present disclosure.

### DETAILED DESCRIPTION OF ILLUSTRATIVE EMBODIMENTS

Hereinafter, preferred embodiments of the present disclosure will be described in detail with reference to the attached drawings.

The advantages and features of the present disclosure and methods for achieving the same will become apparent by referring to the embodiments described in detail below together with the attached drawings.

However, the present disclosure is not limited to the embodiments disclosed below, but may be implemented in various different forms, and the present embodiments are provided only to make the present disclosure complete and to fully inform a person having ordinary skill in the art to which the present disclosure belongs of the scope of the present disclosure, and the present disclosure is defined only by the scope of the claims.

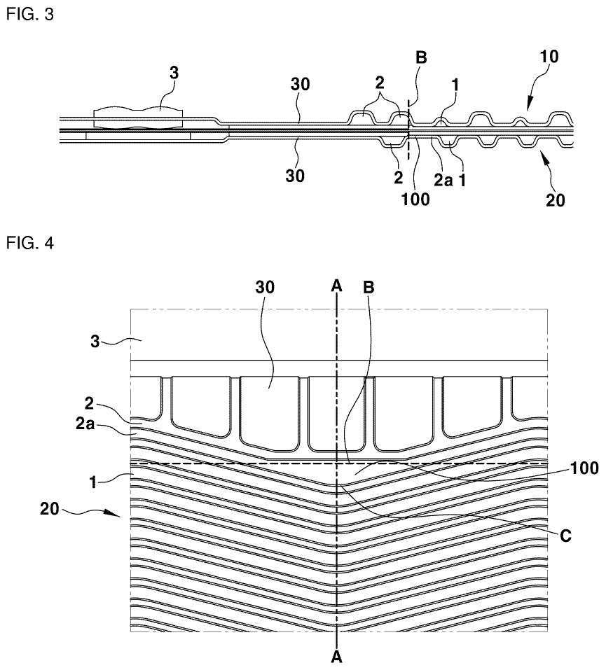

FIG. 2 shows a land extension of a separator for a fuel cell according to a first embodiment of the present disclosure, and FIG. 3 is a cross-sectional view along line A-A of FIG. 2 to show the land extension of the separator for a fuel cell according to the first embodiment of the present disclosure.

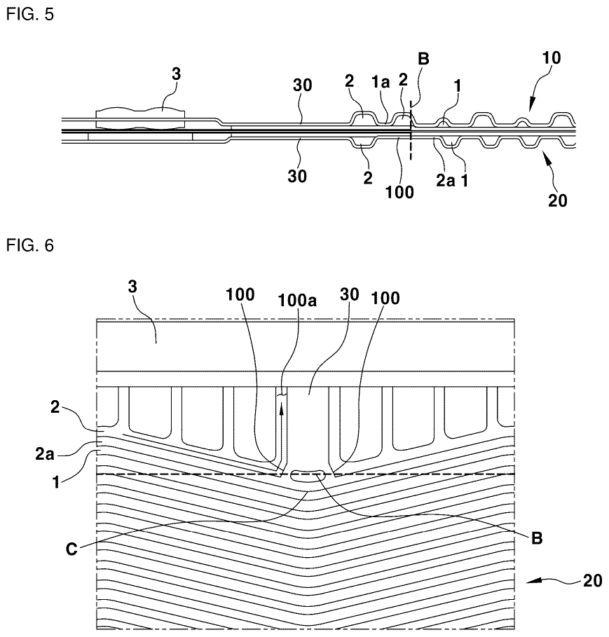

In addition, FIG. 4 shows a land extension of a separator for a fuel cell according to a second embodiment of the present disclosure, FIG. 5 is a cross-sectional view along line A-A of FIG. 4 to show the land extension of the separator for a fuel cell according to the second embodiment of the present disclosure, and FIG. 6 shows a land extension of a separator for a fuel cell according to a third embodiment of the present disclosure.

In a typical fuel cell, each of a plurality of unit cells that are repeatedly stacked is configured to include a membrane-electrode assembly (MEA), a gas diffusion layer (GDL), and a separator. The separator may have a structure including various types of flow paths.

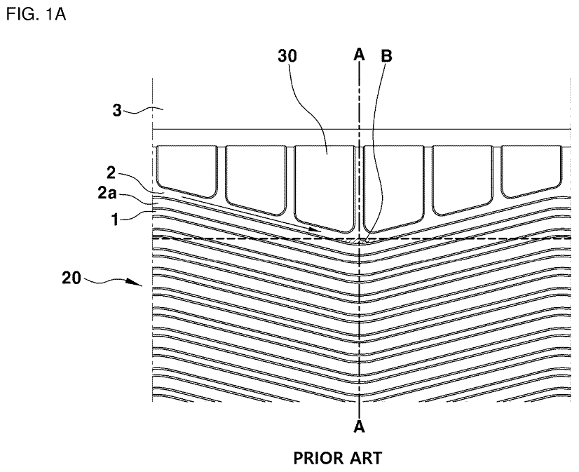

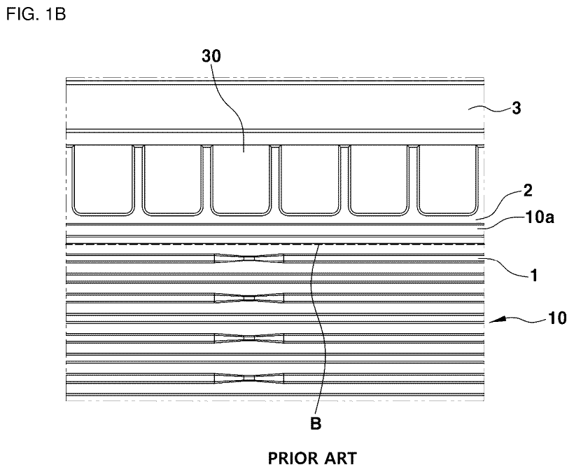

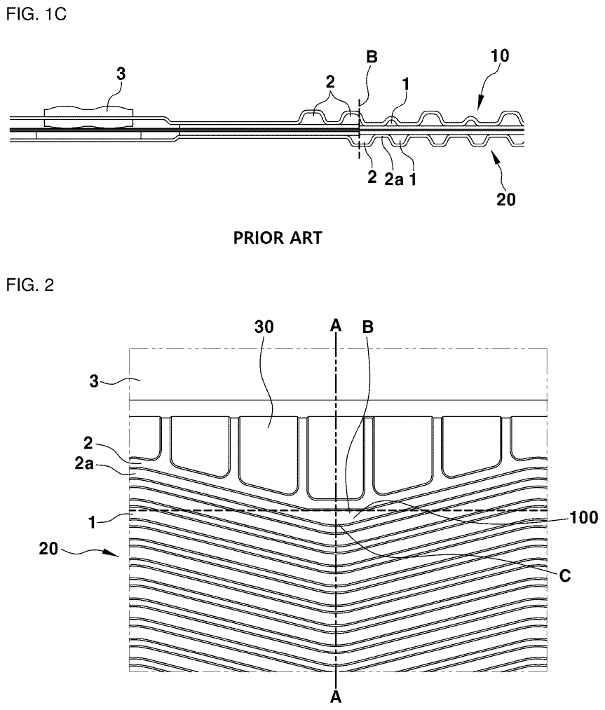

Among these, FIG. 1B shows a flow path that connects an inlet and an outlet. A reaction gas flows through the flow path. The flow path may extend in a straight direction so that the reaction gas may flow in a parallel channel. FIG. 1A shows another flow path that connects an inlet and an outlet. A reaction gas flows through the flow path. The flow path may extend in a wave-like shape so that the reaction gas may flow in a wavy channel.

A flow path that provides the reaction gas flowing to a predetermined reaction area B is referred to as a reaction flow path 1 (carrying, e.g., oxygen), and a flow path that is not included in the reaction area B and formed along the periphery without participating in the reaction is referred to as a non-reaction flow path 2 (carrying, e.g., hydrogen) as shown in FIGS. 1A and 1B.

In the parallel channel shown in FIG. 1B, since the flow path is formed in a straight shape, the uppermost non-reaction flow path 2 does not influence the reaction area B. However, in the wavy channel shown in FIG. 1A, due to changes in phase difference, the reaction gas may influence the reaction area B while flowing along the folded portion of the uppermost non-reaction flow path 2, namely the valley portion formed in a wavy shape (FIG. 1C).

Accordingly, the reaction gas, namely hydrogen, of the non-reaction flow path 2 that influences the valley portion of the wavy channel reacts with the reaction gas, namely oxygen, of the reaction flow path 1 at the reaction area B of the parallel channel, generating water and the water accumulates in the land portion 2a (FIG. 1A).

Since the reaction gas flowing along the non-reaction flow path 2 is introduced and flows in small amounts, the accumulated water cannot be discharged at—a required rate so flooding occurs in the land portion 2a due to the accumulated water. The accumulated water ultimately affects the durability of the membrane-electrode assembly (MEA), thereby deteriorating reliability and performance of the fuel cell stack.

Thus, the separator for a fuel cell according to the present embodiment is capable of solving the above problem by providing a land extension 100 with a predetermined length in the land portion 2a (directly) adjacent to the non-reaction flow path 2 that invades the valley portion of the wavy channel, as shown in FIG. 2.

Specifically, the separator for a fuel cell comprises a first separator 10 including a parallel channel flow path and a second separator 20 including a wavy channel flow path so that they facing each other at a reaction area B formed at the same position. A land extension 100 is formed at a bent area C of the land portion 2a for connecting the non-reaction flow path 2 located at the top of the second separator 20 and the reaction flow path 1 at the reaction area B.

In other words, as described in FIGS. 2 and 3, the land extension 100 is extended (having a predetermined length) to cover the folded area C of the land portion 2a. The folded area C is covered with respect to the second separator 20 including the wavy channel flow path facing the first separator 10, as shown in FIGS. 2 and 3, and is formed such that the length thereof extends beyond a boundary of the reaction area B.

As described above (FIGS. 1A to 1C), since the phase difference of the wavy channel flow path changes in the second separator 20, the reaction gas flowing along the uppermost non-reaction flow path 2 may invade the reaction area B at the folded area C, and thus, the invasion of the non-reaction flow path 2 to the boundary of the reaction area B is blocked through the land extension 100 at the folded area C of the land portion 2a adjacent to the non-reaction flow path 2, thereby structurally preventing hydrogen in the non-reaction flow path 2 from reacting with the oxygen of the first separator 10.

Therefore, it is possible to prevent the non-reaction flow path 2 from impacting the reaction area B and to suppress generating water accumulating in the folded area C of the non-reaction flow path 2 as much as possible. Moreover, it is possible to improve water discharge performance in a low-temperature/low-current density area where discharge of water from the fuel cell stack is difficult.

Furthermore, in the separator for a fuel cell in which the first separator 10 and the second separator 20 are stacked so that reaction areas B coincide with each other (FIG. 3), the land extension 100 may be formed extending in a direction in which the folded area C faces the top of the second separator 20 to coincide with the boundary for forming the reaction area B.

In addition, since the land extension 100 is provided in a form that covers the folded area C of the non-reaction flow path 2. The land extension may be formed to extend in a direction of flow of the reaction gas so that one side extending from the folded area C to one side has the same length as the other side extending from the folded C to the other side and the center side (top side) has a greater length than the one side and the other side.

In this way, the structure in which the land extension 100 is formed to coincide with the boundary of the reaction area B merely corresponds to any one embodiment and is not fixed.

As shown in FIG. 4, the land extension 100 may be formed having a predetermined length in a direction of flow of the reaction gas. The land extension 100 at the folded area C and at the top of the second separator 20 exceeds the boundary of the reaction area B.

Moreover, as shown in FIG. 5, the land extension 100 may be formed to face the outermost land portion 10a connecting the non-reaction flow path 2 in the first separator 10 (FIG. 1B), and accordingly, the land portion 2a of the second separator 20 is located to include the land extension 100 so as to face the land portion 10a, thereby making it possible to additionally obtain rigidity for supporting the first separator 10.

Here, as in the embodiment described above, the land extension 100 is provided in a form that covers the folded area C of the non-reaction flow path 2, and thus it may be formed to extend in a direction of flow of the reaction gas so that one side has the same length as the other side and the center side has a greater length than the one side and the other side.

Meanwhile, the land extension 100 may be formed to be connected to a reverse forming portion 30 that is folded in an opposite direction facing the gas diffusion layer in the folded area C.

As shown in FIG. 6, such a land extension 100 may be formed by connecting the land portion 2a to the reverse forming portion 30. The land portion 2a may be connected to the reverse forming portion 30 at one side and the other side of the folded area C. By connection the reverse forming portion 30 to the land portion 2a in this way, a circulation flow path 100a for the reaction gas in a direction from the non-reaction flow path 2 toward the gasket 3 may be formed. The circulation flow path may be formed by connecting the land portion and the reverse forming portion.

In this way, the land extension 100 may serve to block an inflow of the reaction gas into the reaction area B. By connecting, to the reverse forming portion 30, each of one side and the other side of the folded area C of the land portion 2a adjacent to the non-reaction flow path 2 located at the top of the second separator 20 through which the reaction gas may penetrate the reaction area B, and by forming a predetermined circulation flow path 100a between the same and the reverse forming portion 30, the reaction gas may flow toward the gasket 3 through the circulation flow path 100a.

Accordingly, by connecting the land portion 2a of the non-reaction flow path 2 and the reverse forming portion 30 through the land extension 100 at one side and the other side, the reaction gas flowing along the non-reaction flow path 2 in the second separator 20 cannot flow to the reaction area B between land extensions 100, thereby effectively preventing generation of water in the non-reaction flow path.

According to the present disclosure, in the separator structure in which a parallel channel and a wavy channel are repeatedly stacked, the land of the non-reaction flow path of the wavy channel that penetrates the reaction area is increased, thus preventing generation of water in the non-reaction flow path, thereby improving water discharge performance in a low-temperature/low-current section in which water discharge performance is weakened, effectively improving performance of the stack.

Accordingly, the present disclosure is effective in improving durability of the stack by preventing deterioration due to accumulation of water in the non-reaction flow path.

In addition, the present disclosure is effective at reducing durability deterioration of the stack due to freezing of water accumulated in the non-reaction flow path under sub-zero conditions.

As is apparent from the foregoing, according to the present disclosure, in a separator structure in which a parallel channel and a wavy channel are repeatedly stacked, the land of the non-reaction flow path of the wavy channel that invades the set reaction area is increased, thus preventing generation of water in the non-reaction flow path, thereby improving water discharge performance in a low-temperature/low-current section in which water discharge performance is weakened, ultimately effectively improving performance of the stack.

Thus, the present disclosure has the effect of improving durability of the stack because it can prevent deterioration due to accumulation of water in the non-reaction flow path.

In addition, the present disclosure has the effect of reducing durability deterioration of the stack due to freezing of water accumulated in the non-reaction flow path under sub-zero conditions.

Although the present disclosure has been described with reference to the embodiment(s) shown in the drawings, these embodiments are merely exemplary, and those skilled in the art will understand that various modifications may be made therefrom, and that all or part of the embodiment(s) described may be selectively combined and configured. Therefore, the technical scope of the present disclosure should be determined by the technical idea of the appended claims.

What is claimed is:

1. A separator arrangement comprising:
a first separator comprising a straight channel flow path; and
a second separator comprising a wavy channel flow path,
wherein the first and second separators are repeatedly stacked, and
wherein the second separator comprises a land extension formed in a folded area of a land portion adjacent to a non-reaction flow path located at a top of the second separator in a reaction area of each of the first separator and the second separator.

2. The separator arrangement of claim 1, wherein the land extension is formed to extend in a direction in which the folded area faces the top of the second separator to coincide with a boundary position for forming the reaction area.

3. The separator arrangement of claim 2, wherein the land extension is formed to extend in a direction of flow of a reaction gas in the folded area so that a length of one side is identical to a length of another side and a length of a center side is greater than lengths of the one side and the other side.

4. The separator arrangement of claim 1, wherein the land extension is formed to extend in a direction in which the folded area faces the top of the second separator to exceed a boundary position for forming the reaction area.

5. The separator arrangement of claim 4, wherein the land extension is formed to face the land portion of the non-reaction flow path located at a top of the first separator.

6. The separator arrangement of claim 4, wherein the land extension is formed to extend in a direction of flow of a reaction gas in the folded area so that a length of one side is identical to a length of another side and a length of a center side is greater than lengths of the one side and the other side.

7. The separator arrangement of claim 1, wherein the land extension is formed to be connected to a reverse forming portion that is folded in an opposite direction facing a gas diffusion layer in the folded area.

8. The separator arrangement of claim 7, wherein the land extension is formed at each of one side and another side of the folded area and is connected to the reverse forming portion.

9. The separator arrangement of claim 7, wherein a circulation flow path for a reaction gas in the non-reaction flow path is formed by connecting the land extension to the reverse forming portion.

10. The separator arrangement of claim 1, wherein the first separator is formed so that oxygen flows along the straight channel flow path, and the second separator is stacked to face the first separator so that reaction areas coincide with each other, and is formed so that hydrogen flows along the wavy channel flow path.

11. A separator arrangement comprising:
a first separator comprising a straight channel flow path; and
a second separator comprising a wavy channel flow path,
wherein the straight channel flow path and the wavy channel flow path face each other at a reaction area,
wherein the second separator further comprises a land portion adjacent to the wavy channel flow path,
wherein land portion comprises a land extension formed at a folded area of the wavy channel flow path, and
wherein the land extension extends to a boundary of the reaction area.

12. The separator arrangement of claim 11, wherein the land extension extends beyond the boundary of the reaction area.

13. The separator arrangement of claim 11, wherein the straight channel flow path is configured to carry oxygen and the wavy channel flow path is configured to carry hydrogen.

14. The separator arrangement of claim 11, wherein the wavy channel flow path is a flow path closest to a reverse forming portion.

15. The separator arrangement of claim 11, wherein the land portion is directly adjacent to the wavy channel flow path.

16. The separator arrangement of claim 11, wherein the wavy channel flow path is arranged between the land portion and a reverse forming portion.

17. A separator arrangement comprising:
a first separator comprising a straight channel flow path; and
a second separator comprising a wavy channel flow path,
wherein the straight channel flow path and the wavy channel flow path face each other at a reaction area,
wherein the second separator further comprises a land portion and a reverse forming portion, the wavy channel flow path arranged between the land portion and the reverse forming portion, and
wherein the land portion connects to the reverse forming portion on each side of a folded area of the wavy channel.

18. The separator arrangement of claim 17, wherein the land portion connects to the reverse forming portion outside of the reaction area.

19. The separator arrangement of claim 17, wherein the wavy channel flow path forms a circulation flow path in the reverse forming portion.

20. The separator arrangement of claim 17, wherein the straight channel flow path is configured to carry oxygen and the wavy channel flow path is configured to carry hydrogen.
